(19) United States
(12) Patent Application Publication
(10) Pub. No.: US 2024/0413869 A1
(43) Pub. Date: Dec. 12, 2024

(54) TEMPORARY REFERENCE SIGNAL-BASED SECONDARY CELL ACTIVATION VIA RADIO RESOURCE CONTROL

(71) Applicant: Telefonaktiebolaget LM Ericsson (publ), Stockholm (SE)

(72) Inventors: Zhenhua ZOU, Solna (SE); Lian ARAUJO, Solna (SE); Pontus WALLENTIN, Linköping (SE); Stefan WAGER, Espoo (FI)

(21) Appl. No.: 18/699,833

(22) PCT Filed: Oct. 10, 2022
(86) PCT No.: PCT/IB2022/059698

§ 371 Date: Apr. 9, 2024

Related U.S. Application Data
(60) Provisional application No. 63/256,000, filed on Oct. 15, 2021.

(51) Int. Cl. H04B 7/06; H04W 72/0446; H04W 76/27

(52) U.S. Cl. CPC H04B 7/0626; H04W 72/0446; H04W 76/27

(57) ABSTRACT

A method performed by a user equipment, UE, for temporary reference signal-based secondary cell, SCell, activation via radio resource control, RRC, is provided. The method includes receiving a RRC message indicating that the SCell is to be activated. The RRC message includes configuration information associated with a temporary reference signal, TRS. Based on the configuration information in the RRC message, the UE receives the TRS. The UE transmits a channel state information, CSI, report for the SCell based on the TRS.

### TECHNICAL FIELD

The present disclosure relates, in general, to wireless communications and, more particularly, systems and methods for temporary reference signal-based Secondary Cell (SCell) activation via radio resource control (RRC).

### BACKGROUND

When carrier aggregation (CA) is configured, the user equipment (UE) only has one radio resource control (RRC) connection with the network. Further, at RRC connection establishment, re-establishment, and/or handover, one serving cell provides the non-access stratum (NAS) mobility information. Likewise, at RRC connection re-establishment or handover, one serving cell provides the security input. This cell is referred to as the Primary Cell (PCell). In addition, depending on UE capabilities, Secondary Cells (SCells) can be configured to form, together with the PCell, a set of serving cells. Therefore, when carrier aggregation is configured for the UE, the set of serving cells used by the UE consists of one PCell and one or more SCells.

The reconfiguration, addition, and removal of SCells can be performed by RRC. At intra-radio access technology (RAT) handover, RRC can also add, remove, or reconfigure SCells for usage with the target PCell. When adding a new SCell, dedicated RRC signaling is used for sending all required system information of the SCell. For example, while in connected mode, UEs need not acquire broadcasted system information directly from the SCells.

To enable reasonable UE battery consumption when CA is configured, an activation/deactivation mechanism of cells is supported. When an SCell is deactivated, the UE does not need to receive the corresponding physical downlink control channel (PDCCH) or physical downlink shared channel (PDSCH). Additionally, the UE cannot transmit in the corresponding uplink, nor is it required to perform channel quality indicator (CQI) measurements. Conversely, when an SCell is active, the UE shall receive PDSCH and PDCCH (if the UE is configured to monitor PDCCH from this SCell) and is expected to be able to perform CQI measurements. Next Generation-Radio Access Network (NG-RAN) ensures that while physical uplink control channel (PUCCH) SCell (a Secondary Cell configured with PUCCH) is deactivated, SCells of a secondary PUCCH group (a group of SCells whose PUCCH signaling is associated with the PUCCH on the PUCCH SCell) should not be activated. NG-RAN ensures that SCells mapped to PUCCH SCell are deactivated before the PUCCH SCell is changed or removed.

When reconfiguring the set of serving cells, SCells added to the set are initially activated or deactivated. SCells which remain in the set (either unchanged or reconfigured) do not change their activation status (activated or deactivated).

At handover or connection resume from RRC_INACTIVE, SCells are activated or deactivated.

To enable reasonable UE battery consumption when CA is configured, only one uplink (UL) bandwidth part (BWP) for each UL carrier and one downlink (DL) BWP or only one DL/UL BWP pair can be active at a time in an active serving cell. All other BWPs that the UE is configured with are deactivated. On deactivated BWPs, the UE does not monitor the PDCCH and does not transmit on PUCCH, Physical Random Access Channel (PRACH), and Uplink-Shared Channel (UL-SCH).

To enable fast SCell activation when CA is configured, one dormant BWP can be configured for an SCell. If the active BWP of the activated SCell is a dormant BWP, the UE stops monitoring PDCCH and transmitting Sounding Reference Signal (SRS)/PUSCH/PUCCH on the SCell but continues performing CSI measurements, Automatic Gain Control (AGC) and beam management, if configured. Downlink Control Information (DCI) is used to control entering/leaving the dormant BWP for one or more SCell(s) or one or more SCell group(s).

The dormant BWP is one of the UE's dedicated BWPs configured by network via dedicated RRC signaling. The Special Cell (SpCell) and PUCCH SCell cannot be configured with a dormant BWP.

If the Medium Access Control (MAC) entity is configured with one or more SCells, the network may activate and deactivate the configured SCells. Upon configuration of an SCell, the SCell is deactivated unless the parameter sCellState is set to activated for the SCell by upper layers.

The configured SCell(s) is activated and deactivated by:
receiving the SCell Activation/Deactivation MAC Control Element (MAC CE) described;
configuring sCellDeactivationTimer timer per configured SCell (except the SCell configured with PUCCH, if any): the associated SCell is deactivated upon its expiry;
configuring sCellState per configured SCell: if configured, the associated SCell is activated upon SCell configuration.

Only SCells can be put to dormant state (in Long Term Evolution (LTE)) or operate in dormancy like behavior (NR). Also, only SCells can be put into the deactivated state in both LTE and NR. Thus, if the UE is configured with multi-radio dual connectivity (MR-DC), it is not possible to fully benefit from the power saving options of dormant state or dormancy like behavior as the Primary Secondary Cell (PSCell) cannot be configured with that feature. Instead, an existing solution could be releasing (for power savings) and adding (when traffic demands requires) the Secondary Cell Group (SCG) on a need basis. However, traffic is likely to be bursty, and adding and releasing the SCG involves a significant amount of RRC signaling and inter-node messaging between the Master Node (MN) and the Secondary Node (SN), which causes considerable delay.

In Rel-16, some discussions were made regarding putting also the PSCell in dormancy, which is referred to as SCG Suspension. Some preliminary agreements were made in RAN2-107bis, October 2019 (see chairman notes at R2-1914301):
R2-1914301 assumes the following (can be slightly modified due to progress on SCell dormancy):
   The UE supports network-controlled suspension of the SCG in RRC_CONNECTED.
   UE behavior for a suspended SCG is For Future Study (FFS).
   The UE supports at most one SCG configuration, suspended or not suspended, in Rel16.
   In RRC_CONNECTED upon addition of the SCG, the SCG can be either suspended or not suspended by configuration.

In RAN2-108 meeting, further discussion was made to clarify the above FFSs.

Some solutions have been proposed in Rel-16, but these have different problems. For example, R2-1908679 proposes that the gNodeB (gNB) can indicate to the UE to suspend SCG transmissions when no data traffic is expected to be sent in SCG so that UE keeps the SCG configuration but, for power saving purposes, does not use it. Therein, it is mentioned that signaling to suspend SCG could be based on DCI/MAC-CE/RRC signaling, but no details were provided regarding the configuration from the gNB to the UE. And, differently from the defined behavior for SCell(s), PSCell(s) may be associated to a different network node such as, for example, a gNB operating as SN).

For Rel-17, the following has been agreed for the deactivated SCG:
RRC configuration can select SCG activation state. This can be set using the RRCReconfiguration message at handover, resume, PSCell change or SCG modification.
The UE does not receive PDCCH/PDSCH on PSCell and there is no PUSCH transmission PSCell.
All SCG SCells are deactivated.
SCG reconfiguration via Master Cell Group (MCG) is supported.
UE continues Radio Resource Management (RRM) measurements and reporting and PSCell mobility is supported.
Both RACH and RACH-less SCG activation are supported.
UE keeps the Time Alignment timer running and considers Timing Advance (TA) valid as long as the timer is running.
UE continues Beam Failure Detection (BFD)/Radio Link Monitoring (RLM) (if configured).

Typically, the SCell activation procedure can take anywhere between a minimum activation delay (on order of a few milliseconds) to up to multiple 10's or 100's of milliseconds. FIG. 1 illustrates that, upon reception of an SCell activation command (e.g. via a MAC CE), a UE starts the activation procedure for the corresponding SCell, wherein the activation delay includes a component related to a delay to first Synchronization Signal Block (SSB) delay after the slot in which the Acknowledgment (ACK) is transmitted responsive to reception of Activation command MAC CE. The activation procedure is assumed to be complete (i.e. the SCell is considered activated) when UE sends a valid CSI report for the SCell or the maximum allowed SCell activation delay is reached. The UE is supposed to complete the activation procedure based on certain minimum requirements which are scenario-dependent and are captured in the 3GPP RAN4 specifications 3GPP TS 38.133.

For example, in section 8.3.2 of 3GPP TS 38.133, it is specified that upon receiving SCell activation command in slot n, the UE shall be capable to transmit valid CSI report and apply actions related to the activation command for the SCell being activated no later than in

$$slot n + \frac{{T}_{HARQ} + {T}_{activation \_ time} + {T}_{CSI \_ Reporting}}{NR slot length} .$$

T_{HARQ} is measured in ms and is the timing between DL data transmission and the ACK as specified in 3GPP TS 38.213. T_{activation_time} is the SCell activation delay in milliseconds, which depends on whether SCell is known, whether SCell belongs to Frequency Range 1 (FR1)/Frequency Range 2 (FR2), and the time to the first SSB.

To activate a cell, the UE need to obtain accurate synchronization and adjust the Radio Frequency (RF) gain. In order to do this, the UE need to measure at least two separate reference signals. In NR, the SSB periodicity can be up to 160 milliseconds, and including beam sweeping, the SCell activation delay could be several seconds. To speed up SCell activation, it has been proposed to introduce temporary reference signals (TRSs), which are activated when an SCell is activated. The idea is that the UE will have more reference signals to measure on.

FIG. 2 illustrates a faster SCell activation timeline as is being considered in 3GPP. In this procedure, along with the SCell activation command, the UE is provided with an additional reference signal known as TRS, which can be, for example, an aperiodic tracking reference signal (A-TRS). Thus, the UE can immediately utilize the TRS instead of waiting for the first SSB to start the activation procedure, thereby reducing the activation time. The activation procedure is assumed to be complete (i.e., the SCell is considered activated) when the UE sends a valid CSI report for the SCell or when the maximum allowed SCell activation delay is reached, which can be smaller when the UE is activating using TRS as compared to activating without TRS. FIG. 2 also shows the UE receiving CSI-RS on the SCell being activated and then measuring and reporting a valid CSI report. Thereafter, the SCell is considered activated.

3GPP has agreed to utilize MAC CE(s)-based design for triggering TRS (such as A-TRS) for fast SCell activation. It has been proposed that a bitmap structure be used for the UE to obtain A-TRS presence information during an SCell activation procedure, including the possibility of obtaining additional TRS parameter signaling. Particularly, the UE may obtain burst information in the MAC CE.

In RAN1 #106e, the following is agreed:
To trigger TRS,
   MAC-CE at least provides the following information:
      TRSs are to be triggered on X out of Y (Y≥X) to-be-activated SCells, respectively, while no TRS is to be triggered on the other to-be-activated SCells.
   The following information can be provided by RRC for TRS for each SCell
      The number of RS bursts and the gap length between the RS bursts
      Triggering offset of TRS
      QCL information
   Information for 0, 1, or more TRS can be provided for each configured SCell
For triggering TRS, down-select based on the following alternatives:
   Alt 1: Bitmap approach in MAC-CE
      Every Z-bit block in the bitmap corresponds to a SCell, Z>=0
      A Z-bit block indicates the TRS [configuration index], and a value zero indicated by the bit block means no RS resource transmitted.
      The to-be-activated SCell is indicated via the C values in the legacy SCell activation/de-activation MAC CE or in the new MAC-CE
   Alt 2: Reuse A-TRS triggering framework
      A trigger state is indicated by the MAC-CE explicitly
      The association between a trigger state and TRS for one or multiple SCells is configured by RRC according Rel-16 A-TRS triggering framework

Direct SCell activation is also possible via RRC. For example, in the RRC reconfiguration message, the network can set the parameter sCellState for one SCell to activated. Upon the UE receiving this message, the UE shall activate the SCell directly according to a specified delay in the section 8.3.4 of 3GPP TS 38.133. This applies to SCell addition, handover, and RRCResume.

For example, for SCell addition, it is specified that the UE shall configure the SCell in activated state upon successful completion of the RRC reconfiguration procedure within the specified delay. Upon receiving the RRC reconfiguration message in subframe n, the UE shall be capable to transmit valid CSI report and apply actions for the directly activated SCell no later than in

$$slot n + \frac{{N}_{direct}}{NR slot length} ,$$

where N_{direct}=T_{RRC_Process}+T₁+T_{activiation_time}+T_{CSI_Reporting}. T_{RRC_Process} is the RRC procedure delay defined in section 12 of 3GPP TS 38.331. T₁: Delay from

$$slot n + \frac{{T}_{RRC \_ Process}}{NR slot length}$$

until the transmission of RRCConnectionReconfigurationComplete message. T_{activation_time} and T_{CSI_Reporting} are specified the same as when SCell is activated by the MAC CE and, for example, are subject to the delay of the first SSB.

There currently exist certain challenges with SCell activation. In the cases of high-volume data arrival at the UE and SCells that have not been configured by the network, it is beneficial to quickly activate the SCells upon the addition of the SCell by RRC. The direct activation of SCell by RRC is supported, but it is not clear if and how the configuration of the TRS upon SCell addition by RRC can be supported. If not supported, the activation delay would be subject to the delay of the first SSB, which may be unacceptable in some cases.

### SUMMARY

Certain aspects of the disclosure and their embodiments may provide solutions to these or other challenges. According to embodiments, methods and systems are provided for determining how and/or when the UE is to activate SCell(s) that are directly activated by a RRC message. For example, the UE may receive an RRC message that includes some configuration of TRSs to be used upon SCell activation and be provided with mechanisms for finding those TRSs. Where the RRC message to directly activate SCell is without TRS configuration, a MAC CE may be used to activate SCell with TRS.

According to certain embodiments, a method performed by a UE for temporary reference signal-based SCell activation via RRC includes receiving, from a network node, a RRC message indicating that the SCell is to be activated. The RRC message comprising configuration information associated with a temporary reference signal, TRS. Based on the configuration information in the RRC message, the UE receives the TRS. The UE transmits, to the network node, a CSI report for the SCell based on the TRS.

According to certain embodiments, a method performed by a UE for temporary reference signal-based SCell activation via RRC includes receiving a RRC message indicating that the SCell is to be activated. The UE receives a MAC CE to activate the SCell with a TRS, and the MAC CE is received after the RRC message. The UE transmits a CSI report for the SCell based on the TRS.

According to certain embodiments, a UE for temporary reference signal-based SCell activation via RRC includes processing circuitry configured to receive, from a network node, a RRC message indicating that the SCell is to be activated. The RRC message comprising configuration information associated with a temporary reference signal, TRS. Based on the configuration information in the RRC message, the processing circuitry is configured to receive the TRS and transmit, to the network node, a CSI report for the SCell based on the TRS.

According to certain embodiments, a UE for temporary reference signal-based SCell activation via RRC includes processing circuitry configured to receive a RRC message indicating that the SCell is to be activated. The processing circuitry is configured receive a MAC CE to activate the SCell with a TRS. The MAC CE is received after the RRC message. The processing circuitry is configured transmit a CSI report for the SCell based on the TRS.

According to certain embodiments, a method performed by a network node for temporary reference signal-based SCell activation via RRC includes transmitting a RRC message. The RRC message indicates that the SCell is to be activated, and the RRC message includes configuration information associated with a TRS. Based on the configuration information in the RRC message, the network node transmits the TRS and receives a CSI report for the SCell based on the TRS.

According to certain embodiments, a method performed by a network node for temporary reference signal-based SCell activation via RRC includes transmitting a RRC message indicating that the SCell is to be activated and transmitting a MAC CE to activate the SCell with a TRS. The MAC CE is transmitted after the RRC message. The network node receives a CSI report for the SCell based on the TRS.

According to certain embodiments, a network node for temporary reference signal-based SCell activation via RRC includes processing circuitry configured to transmit a RRC message. The RRC message indicates that the SCell is to be activated, and the RRC message includes configuration information associated with a TRS. Based on the configuration information in the RRC message, the processing circuitry is configured to transmit the TRS and receives a CSI report for the SCell based on the TRS.

According to certain embodiments, a network node for temporary reference signal-based SCell activation via RRC includes processing circuitry configured to transmit a RRC message indicating that the SCell is to be activated and transmitting a MAC CE to activate the SCell with a TRS. The MAC CE is transmitted after the RRC message. The processing circuitry is configured to receive a CSI report for the SCell based on the TRS.

Certain embodiments may provide one or more of the following technical advantage(s). For example, with TRS activated, certain embodiments may provide a technical advantage of reducing the delay incurred when directly activating an SCell by RRC from, for example, a couple of hundreds of milliseconds to dozens of milliseconds.

Other advantages may be readily apparent to one having skill in the art. Certain embodiments may have none, some, or all of the recited advantages.

### BRIEF DESCRIPTION OF DRAWINGS

For a more complete understanding of the disclosed embodiments and their features and advantages, reference is now made to the following description, taken in conjunction with the accompanying drawings, in which:

FIG. 1 illustrates that, upon reception of an SCell activation command (e.g. via a MAC CE), a UE starts the activation procedure for the corresponding SCell;

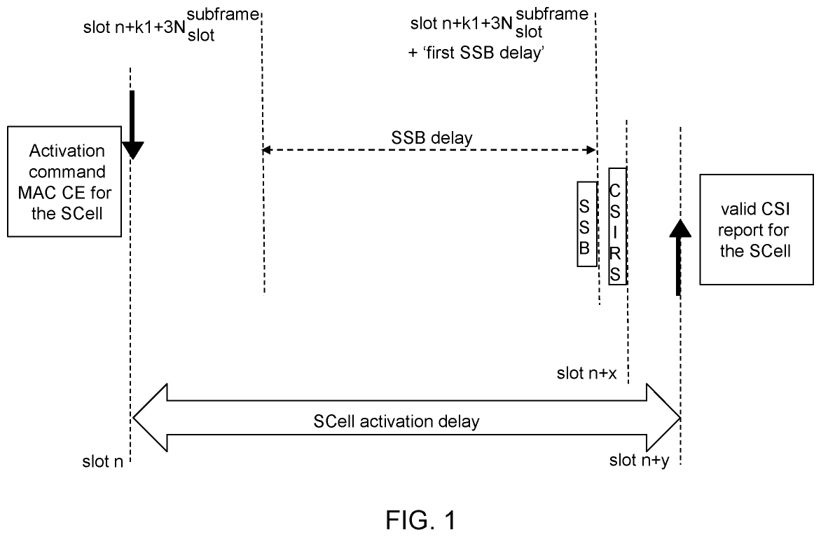

FIG. 2 illustrates a faster SCell activation timeline as is being considered in 3GPP;

FIG. 3 illustrates an example communication system, according to certain embodiments;

FIG. 4 illustrates an example UE, according to certain embodiments;

FIG. 5 illustrates an example network node, according to certain embodiments;

FIG. 6 illustrates a block diagram of a host, according to certain embodiments;

FIG. 7 illustrates a virtualization environment in which functions implemented by some embodiments may be virtualized, according to certain embodiments;

FIG. 8 illustrates a host communicating via a network node with a UE over a partially wireless connection, according to certain embodiments;

FIG. 9 illustrates a method performed by a UE for TRS-based SCell activation via RRC, according to certain embodiments:

FIG. 10 illustrates another method performed by a UE for TRS-based SCell activation via RRC, according to certain embodiments;

FIG. 11 illustrates a method performed by a network node for TRS-based SCell activation via RRC, according to certain embodiments; and

FIG. 12 illustrates another method performed by a network node for TRS-based SCell activation via RRC, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

### SCell and TRS Activated in One RRC Message

According to certain embodiments, an RRC message contains a configuration for direct activation of the SCell upon reception of the RRC message by the UE. The RRC message also contains a configuration of the TRS used for the SCell activation that is indicated by the RRC message.

For example, in this RRC message, the sCellState for this SCell is set to true, in a particular embodiment.
The TRS is triggered by reusing A-TRS triggering framework: In the case where only one TRS trigger state is configured, the TRS indicated by the trigger state is present. If more than one TRS trigger state is configured, the RRC also indicates a particular one that is present/triggered for SCell activation (i.e., without an explicit MAC CE). The TRS trigger state is used in the case when the SCell is later activated again by the MAC CE, after the SCell is de-activated by MAC CE or due to the expiry of the SCell Deactivation Timer. In such a MAC CE-based activation, the network can activate the SCell and, in the same MAC CE, indicate the presence of the TRS by indicating one trigger state from the list of the trigger states.
The TRS is triggered by using the bitmap approach: In the case where only one TRS configuration index is configured for a to-be-activated SCell, the TRS configuration index is present/triggered for the to-be-activated SCell. If more than one TRS configuration index is configured for a to-be-activated SCell, the RRC also indicates a particular one that is present/triggered for SCell activation (i.e., without an explicit MAC CE). The RRC configuration message also contains TRS configuration index for such to-be-activated SCells. Multiple TRS configuration indexes are configured similar to the example discussed above for a later SCell activation by MAC CE.

According to certain embodiments, upon receiving such a RRC message, the UE receives the first TRSs transmitted from the network at the following time slot:
A triggering offset (e.g., K slots) of the TRS is RRC configured while the reference slot (k=0) can be that:
   a) The slot in which the RRCReconfiguration message is received/decoded;
   b) The slot in which the RRCReconfiguration message is received+a fixed duration of RRC message process delay (e.g., 10 ms as in clause 12 of 3GPP TR 38.331). The process delay of the RRC message may be different based on the content of the RRC message, e.g., an RRC reconfiguration message for SCell addition, handover, or RRC Resume.

The UE receives the TRS K slots after the reference slot. Thus, the TRS is present K slots after the reference slot. Here, the value of K can be either fixed by specification, set by UE capability, or signaled to the UE in the RRC message.
The slot in which the UE can receive the TRS is explicitly indicated in the RRC message, for example, a system frame number (SFN, in unit of 10 milliseconds) and a subframe number (in unit of 1 millisecond) and, additionally, a slot number within the subframe;
a) The range of the slot number is numerology dependent. For SCell using 15 KHz subcarrier spacing, there is only one slot in each subframe and, thus, no need to indicate the slot number. For SCells using 2^{u}*15 KHz subcarrier space where u=1, 2, 3, the slot number is any integer number from 1 to 2^{u}.
b) In another particular embodiment, the slot number is not indicated by the gNB but is instead a fixed number. For example, it is always the first slot in the indicated subframe number. The number can either be fixed by specification or set by UE capability.

In another particular embodiment, the RRC message that contains a configuration that the SCell shall be directly activated upon receiving the RRC message and a configuration of the TRS used for this SCell activation can be:
an RRC reconfiguration message in which the SCell is added;
an RRC reconfiguration message for handover;
an RRC reconfiguration message for RRC Resume; or
an RRC reconfiguration message to activate the deactivated SCG.

In another particular embodiment, the triggering offset and the reference slot are different depending on the contents of the RRC message. For example, the triggering offset and the reference slot may be separately configured in each RRC message.

In another particular embodiment, the triggering offset and the reference slots for some RRC configuration messages are the same. For example, the triggering offset and the reference slots are configured upon SCell addition. Upon SCG activation from de-activated state, if the triggering offset and the reference slot are absent in the RRC message that activates the SCG, the UE apply the triggering offset and the reference slot configured in the RRC messages includes the SCell addition.

### TRS Not Activated in the RRC

According to certain other embodiments, it is not allowed to transmit in an RRC message to directly activate the SCell with the TRS. However, the MAC CE-based SCell activation with TRS triggering is supported.

For example, in a particular embodiment, the UE may activate/deactivate SCells with TRS based on multiple received commands containing SCell state information. In one example embodiment, after receiving an RRC configuration message containing SCell state to be activated, the UE also receives a MAC CE to activate/de-activate the SCell with the TRS. The decision as to which SCells to activate can be taken considering:
The SCell state within the later command received (e.g., MAC CE), which implies that regardless of the SCell state present in the first command received, the UE will derive the SCell state solely based on the later command received including the case that the TRS is used in the SCell activation.

In the case of multiple SCell activation commands, several example embodiments are disclosed. In one example embodiments, the delay within which the UE shall be able to activate the deactivated SCell is calculated from when the MAC CE is received at the UE, ignoring the activation timing requirement related with the previously received RRC configuration message. For example, the UE shall be able to transmit valid CSI report and apply action related to the activation command for SCell being activated at slot N₂ where N₁ and N₂ are defined as below:
Upon receiving the RRC configuration message in subframe n₁ to activate the SCell, the UE shall be capable to transmit valid CSI report and apply actions for the directly activated SCell no later than in

$$slot {N}_{1} = {n}_{1} + \frac{{N}_{d i r e c t}}{NR slot length} ,$$

where N_{direct}=T_{RRC_Process}+T₁+T_{activation_time}+T_{CSI_Reporting}. T_{RRC_Process} is RRC procedure delay.
Upon receiving SCell activation command in slot n₂, the UE shall be capable to transmit valid CSI report and apply actions related to the activation command for the SCell being activated no later than in

$$slot {N}_{2} = {n}_{2} + \frac{{T}_{HARQ} + {T}_{activation \_ time} + {T}_{CSI \_ Reporting}}{NR slot length} .$$

T_{HARQ} (in ms) is the timing between DL data transmission and acknowledgement as specified in 3GPP TS 38.213 where T_{activation_time} is the SCell activation delay in millisecond with TRS.

In one example, the delay within which the UE shall be able to activate the SCell, e.g., be able to transmit valid CSI report and apply action related to the activation command for SCell being activated is the closest time in the future, either N₁ or N₂. In other words, if N₁ is closer in time, then the UE shall be able to activate the SCell before N₁. Otherwise, the UE shall be able to activate the SCell before N₂.

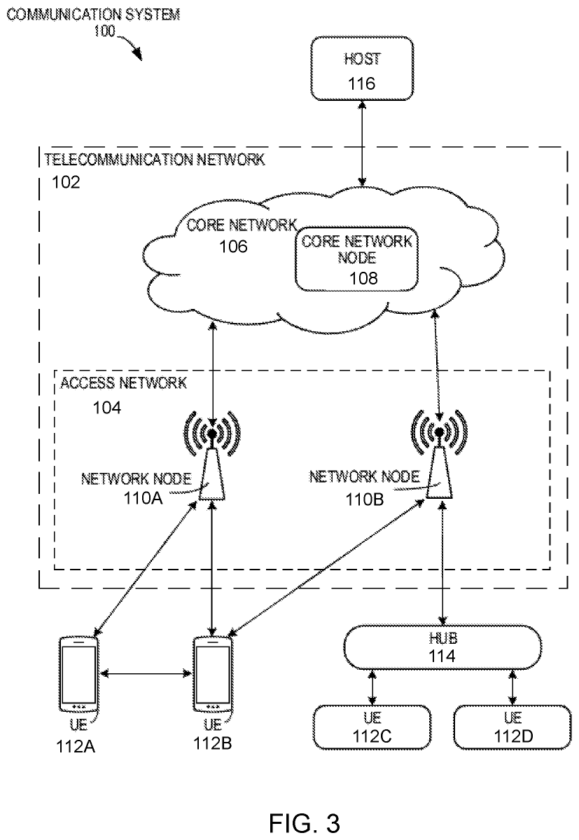

FIG. 3 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of 1 FIG. 3 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

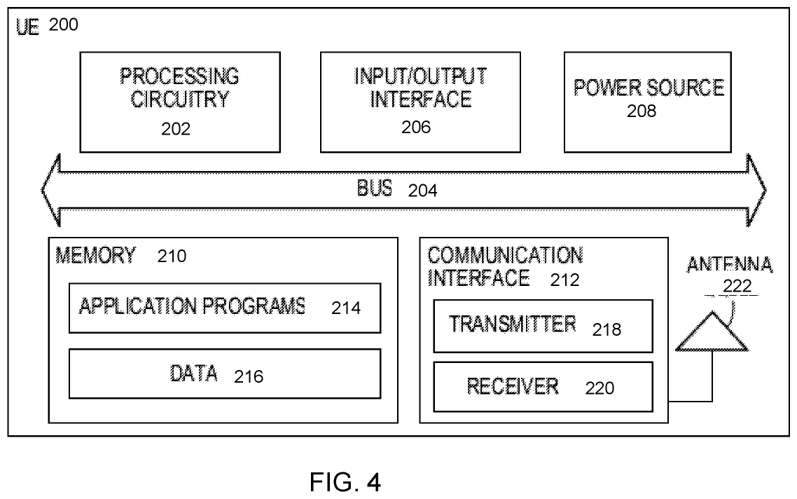

FIG. 4 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 4.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

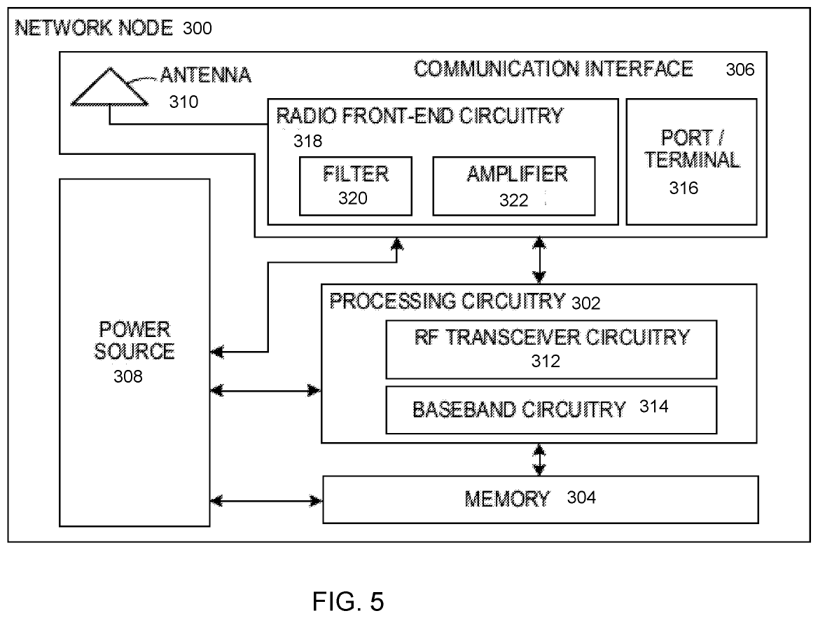

FIG. 5 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 5 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

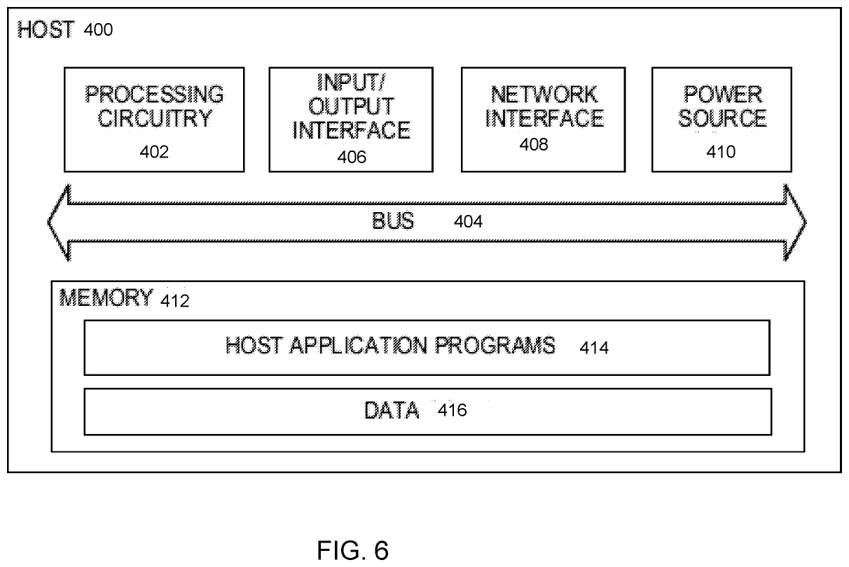

FIG. 6 is a block diagram of a host 400, which may be an embodiment of the host 116 of 1 FIG. 3, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

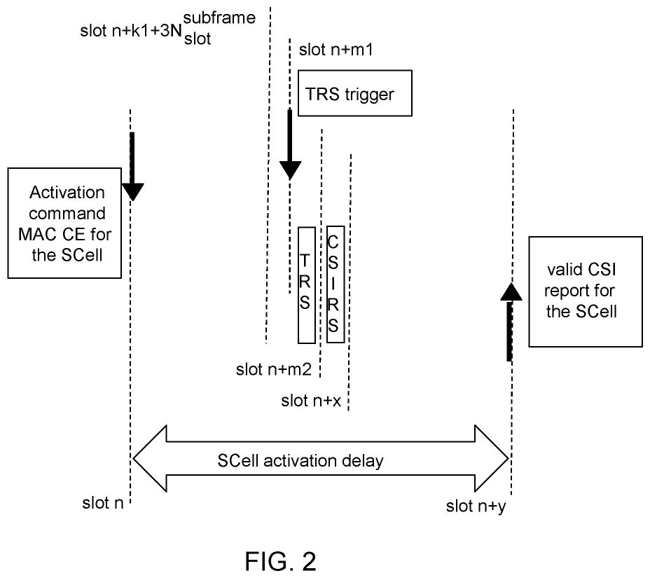

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

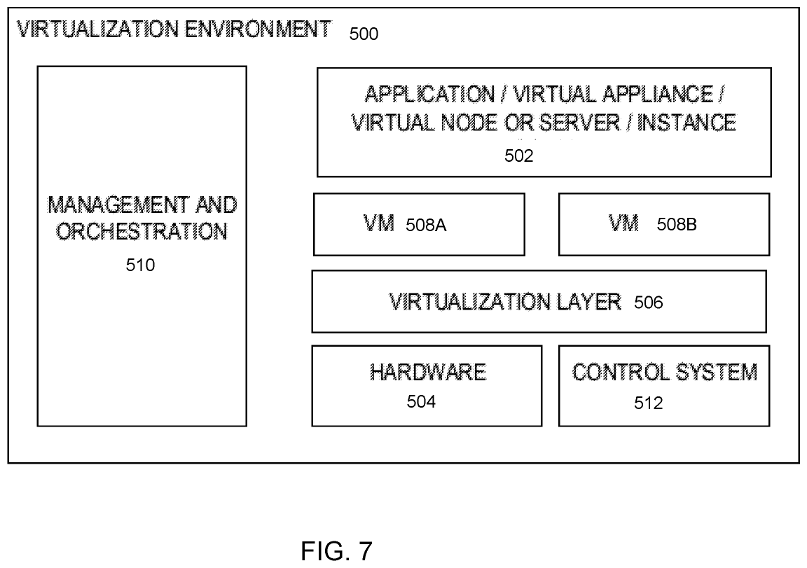

FIG. 7 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

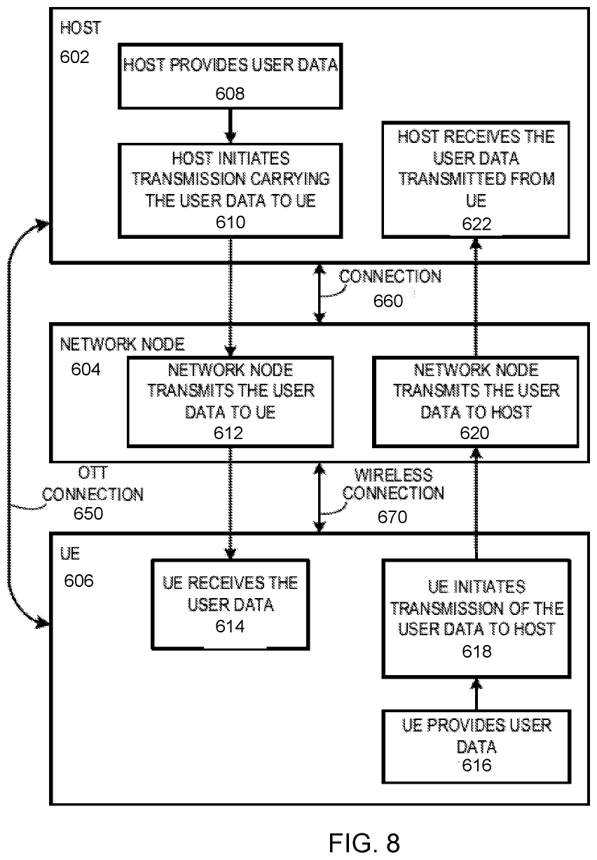

FIG. 8 shows a communication diagram of a host 602 communicating via a network node 604 with a UE 606 over a partially wireless connection in accordance with some embodiments. Example implementations, in accordance with various embodiments, of the UE (such as a UE 112a of FIG. 3 and/or UE 200 of FIG. 4), network node (such as network node 110a of FIG. 3 and/or network node 300 of FIG. 5), and host (such as host 116 of FIG. 3 and/or host 400 of FIG. 6) discussed in the preceding paragraphs will now be described with reference to FIG. 8.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 3) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

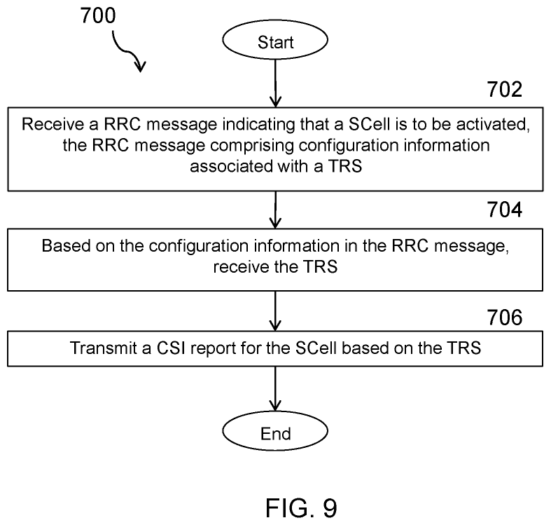

FIG. 9 illustrates a method 700 performed by a UE 112, 200 for TRS-based SCell activation via RRC, according to certain embodiments. The method includes receiving, at step 702, a RRC message. The RRC message indicates that the SCell is to be activated. The RRC message also includes configuration information associated with a TRS. Based on the configuration information in the RRC message, the UE receives the TRS, at step 704. At step 706, the UE transmits a CSI report for the SCell based on the TRS.

In a particular embodiment, the configuration information in the RRC message indicates the TRS to be used to activate the SCell.

In a particular embodiment, the configuration information indicates a time slot for receiving the TRS, and the UE receives the TRS at the time slot indicated in the RRC message.

In a further particular embodiment, the RRC message indicates the time slot for receiving the TRS by indicating a SFN and a subframe number.

In a further particular embodiment, the RRC message indicates a slot number within the subframe number.

In a further particular embodiment, the time slot for receiving the TRS is a fixed slot in the subframe number.

In a particular embodiment, the configuration information indicates a triggering offset after a reference slot, and the UE receives the TRS according to the triggering offset after the reference slot.

In a further particular embodiment, the reference slot is a slot in which the RRC message is received.

In a further particular embodiment, the triggering offset is a fixed value.

In a further particular embodiment, the fixed value is related to a RRC message process delay time.

In a particular embodiment, the triggering offset is set by the user equipment.

In a particular embodiment, the RRC message indicates the triggering offset.

In a particular embodiment, the RRC message is a RRC reconfiguration message in which the SCell is added, a RRC reconfiguration message for handover, a RRC reconfiguration message for RRC Resume, or a RRC reconfiguration message to activate a deactivated secondary cell group, SCG.

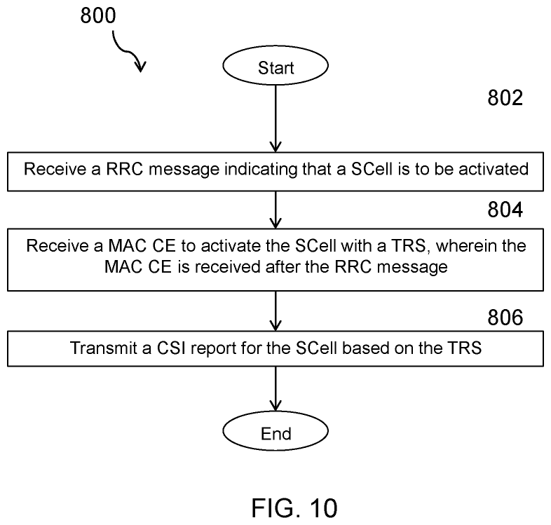

FIG. 10 illustrates another method 800 performed by a UE 112, 200 for TRS-based SCell activation via RRC, according to certain embodiments. The method includes receiving, at step 802, a RRC message that indicates that the SCell is to be activated. At step 804, the UE 112 receives a MAC CE to activate the SCell with a TRS. The MAC CE received at step 804 is received after the RRC message of step 802. At step 806, the UE transmits a CSI report for the SCell based on the TRS.

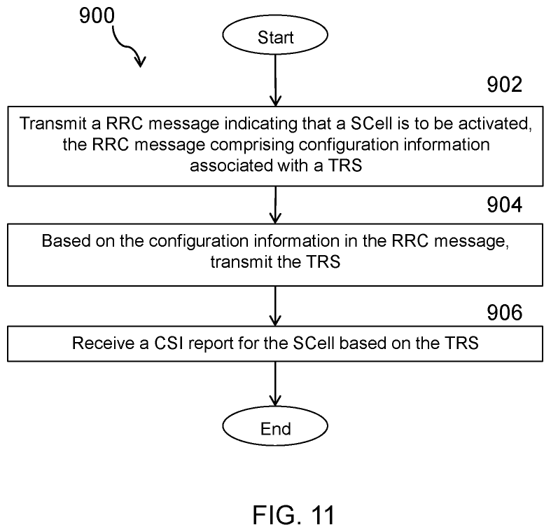

FIG. 11 illustrates a method 900 performed by a network node 110, 300 for TRS-based SCell activation via RRC, according to certain embodiments. The method includes transmitting, at step 902, a RRC message that indicates that the SCell is to be activated. The RRC message includes configuration information associated with a TRS. Based on the configuration information in the RRC message, the network node transmits the TRS, at step 904. At step 906, the network node receives a CSI report for the SCell based on the TRS.

In a particular embodiment, the configuration information in the RRC message indicates the TRS to be used to activate the SCell.

In a particular embodiment, the configuration information indicates a time slot for receiving the TRS, and the method includes transmitting the TRS at the time slot indicated in the RRC message.

In a particular embodiment, the RRC message indicates the time slot that the TRS is transmitted by indicating a SFN and a subframe number.

In a further particular embodiment, the RRC message indicates a slot number within the subframe number.

In a further particular embodiment, the time slot for transmitting the TRS is a fixed slot in the subframe number.

In a particular embodiment, the configuration information indicates a triggering offset after a reference slot, and the IRS is transmitted according to the triggering offset after the reference slot.

In a particular embodiment, the reference slot is a slot in which the RRC message is transmitted.

In a particular embodiment, the fixed value is related to a RRC message process delay time.

In a particular embodiment, the triggering offset is set by the user equipment.

In a particular embodiment, the RRC message indicates the triggering offset.

In a particular embodiment, the RRC message is a RRC reconfiguration message in which the SCell is added, a RRC reconfiguration message for handover, a RRC reconfiguration message for RRC Resume, or a RRC reconfiguration message to activate a deactivated SCG.

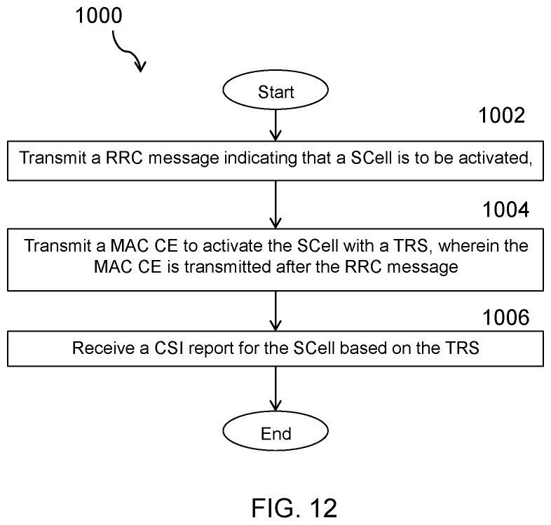

FIG. 12 illustrates another method 1000 performed by a network node 110, 300 for TRS-based SCell activation via RRC, according to certain embodiments. The method begins at step 1002 when the network node transmits a RRC message that indicates that the SCell is to be activated. At step 1004, the network node transmits a MAC CE to activate the SCell with a TRS. The MAC CE transmitted at step 1004 is transmitted after the RRC message is transmitted at step 1002. At step 1006, the network node receives a CSI report for the SCell based on the TRS.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment 1. A method performed by a user equipment for temporary reference signal-based secondary cell activation via radio resource control, the method comprising: receiving a radio resource control (RRC) message, wherein the RRC message is configured to indicate that a secondary cell (SCell) is to be activated; and transmitting a channel state information (CSI) report for the SCell.

Example Embodiment 2. The method of example embodiment 1, wherein the RRC message is configured to indicate that the SCell is to be activated by setting a parameter for the SCell to true.

Example Embodiment 3. The method of example embodiment 2, wherein the parameter is sCellState.

Example Embodiment 4. The method of example embodiment 1, wherein the RRC message is further configured to indicate a temporary reference signal (TRS) used to activate the SCell.

Example Embodiment 5. The method of example embodiment 4, further comprising the step of receiving a temporary reference signal (TRS) at a time slot, wherein the RRC message indicates the time slot for receiving the TRS.

Example Embodiment The method of example embodiment 5, wherein the RRC message indicates the time slot for receiving the TRS by indicating a system frame number (SFN) and a subframe number.

Example Embodiment 7. The method of example embodiment 6, wherein the RRC message further indicates the time slot for receiving the TRS by indicating a slot number within the subframe number.

Example Embodiment 8. The method of example embodiment 6, wherein the time slot for receiving the TRS is a fixed slot in the subframe number.

Example Embodiment 9. The method of example embodiment 4, further comprising the step of receiving a temporary reference signal (TRS), wherein the TRS is received according to a triggering offset after a reference slot.

Example Embodiment 10. The method of example embodiment 9, wherein the reference slot is a slot in which the RRC message is received.

Example Embodiment 11. The method of example embodiment 9, wherein the reference slot is a slot in which the RRC message is received plus a fixed duration related to a RRC message process delay time.

Example Embodiment 12. The method of any of example embodiments 9-11, wherein the triggering offset is a fixed value.

Example Embodiment The method of any of example embodiments 9-11, wherein the triggering offset is set by the user equipment.

Example Embodiment 14. The method of any of example embodiments 9-11, wherein the RRC message indicates the triggering offset.

Example Embodiment 15. The method of any of the previous example embodiments, wherein the RRC message is a RRC reconfiguration message in which the SCell is added.

Example Embodiment 16. The method of any of the previous example embodiments, wherein the RRC message is a RRC reconfiguration message for handover.

Example Embodiment 17. The method of any of the previous example embodiments, wherein the RRC message is a RRC reconfiguration message for RRC Resume.

Example Embodiment 18. The method of any of the previous example embodiments, wherein the RRC message is a RRC reconfiguration message to activate a deactivated secondary cell group (SCG).

Example Embodiment 19. The method of example embodiment 1, further comprising the step of receiving a medium access control (MAC) control element (CE) to activate the SCell with a temporary reference signal (TRS), the MAC CE is received after the RRC message.

Example Embodiment 20. The method of example embodiment 19, further comprising the step of deriving a state of the SCell based on the MAC CE.

Example Embodiment 21. The method of example embodiment 19, wherein the CSI report for the SCell is transmitted within a delay calculated from when the MAC CE to activate the SCell is received.

Example Embodiment 22. The method of example embodiment 19, wherein the RRC message is received in a subframe nᵢ and the MAC CE to activate the SCell is received in a subframe n₂

Example Embodiment 23. The method of example embodiment 22, wherein the UE transmits the CSI report no later than in a slot N₂, wherein the

$$slot {N}_{2} = {n}_{2} + \frac{{T}_{HARQ} + {T}_{activation \_ time} + {T}_{CSI \_ Reporting}}{NR slot length} .$$

Example Embodiment 24. The method of example embodiment 22, wherein the UE transmits the CSI report for the SCell by the earlier of a slot N₁ or a slot N₂, wherein the

$$slot {N}_{1} = {n}_{1} + \frac{{N}_{direct}}{NR slot length} and the slot {N}_{2} = {n}_{2} + \frac{{T}_{HARQ} + {T}_{activation \_ time} + {T}_{CSI \_ Reporting}}{NR slot length} .$$

Example Embodiment 25. The method of any of the previous example embodiments, further comprising: providing user data; and forwarding the user data to a host via the transmission to the network node.

### Group B Embodiments

Example Embodiment 26. A method performed by a network node for temporary reference signal-based secondary cell activation via radio resource control, the method comprising:
transmitting a radio resource control (RRC) message, wherein the RRC message is configured to indicate that a secondary cell (SCell) is to be activated; and receiving a channel state information (CSI) report for the SCell.

Example Embodiment 27. The method of example embodiment 26, wherein the RRC message is configured to indicate that the SCell is to be activated by setting a parameter for the SCell to true.

Example Embodiment 28. The method of example embodiment 27, wherein the parameter is sCellState.

Example Embodiment 29. The method of example embodiment 26, wherein the RRC message is further configured to indicate a temporary reference signal (TRS) used to activate the SCell.

Example Embodiment 30. The method of example embodiment 29, further comprising the step of transmitting a temporary reference signal (TRS) at a time slot, wherein the RRC message indicates the time slot for that the TRS is transmitted.

Example Embodiment 31. The method of example embodiment 30, wherein the RRC message indicates the time slot that the TRS is transmitted by indicating a system frame number (SFN) and a subframe number.

Example Embodiment 32. The method of example embodiment 31, wherein the RRC message further indicates the time slot that the TRS is transmitted by indicating a slot number within the subframe number.

Example Embodiment 33. The method of example embodiment 31, wherein the time slot for transmitting the TRS is a fixed slot in the subframe number.

Example Embodiment 34. The method of example embodiment 29, further comprising the step of transmitting a temporary reference signal (TRS), wherein the TRS is transmitted after a triggering offset after a reference slot.

Example Embodiment 35. The method of example embodiment 34, wherein the reference slot is a slot in which the RRC message is transmitted.

Example Embodiment The method of example embodiment 34, wherein the reference slot is a slot in which the RRC message is transmitted plus a fixed duration related to a RRC message process delay time.

Example Embodiment 37. The method of any of example embodiments 34-36, wherein the triggering offset is a fixed value.

Example Embodiment 38. The method of any of example embodiments 34-36, wherein the triggering offset is set by the user equipment.

Example Embodiment 39. The method of any of example embodiments 34-36, wherein the RRC message indicates the triggering offset.

Example Embodiment 40. The method of any of the previous example embodiments, wherein the RRC message is a RRC reconfiguration message in which the SCell is added.

Example Embodiment 41. The method of any of the previous example embodiments, wherein the RRC message is a RRC reconfiguration message for handover.

Example Embodiment 42. The method of any of the previous example embodiments, wherein the RRC message is a RRC reconfiguration message for RRC Resume.

Example Embodiment 43. The method of any of the previous example embodiments, wherein the RRC message is a RRC reconfiguration message to activate a deactivated secondary cell group (SCG).

Example Embodiment 44. The method of example embodiment 26 further comprising the step of transmitting a medium access control (MAC) control element (CE) to activate the SCell with a temporary reference signal (TRS), the MAC CE is transmitted after the RRC message.

Example Embodiment 45. The method of example embodiment 44, wherein a state of the SCell based on the MAC CE.

Example Embodiment 46. The method of example embodiment 44, wherein the CSI report for the SCell is received within a delay calculated from when the MAC CE to activate the SCell is transmitted.

Example Embodiment 47. The method of example embodiment 44, wherein the RRC message is transmitted in a subframe n₁ and the MAC CE to activate the SCell is transmitted in a subframe n₂

Example Embodiment 48. The method of example embodiment 47, wherein the CSI report is received no later than in a slot N₂, wherein the

$$slot {N}_{2} = {n}_{2} + \frac{{T}_{HARQ} + {T}_{activation \_ time} + {T}_{CSI \_ Reporting}}{NR slot length} .$$

Example Embodiment 49. The method of example embodiment 47, wherein the CSI report for the SCell is received by the earlier of a slot N₁ or a slot N₂, wherein the

$$slot {N}_{1} = {n}_{1} + \frac{{N}_{direct}}{NR slot length} and the slot {N}_{2} = {n}_{2} + \frac{{T}_{HARQ} + {T}_{activation \_ time} + {T}_{CSI \_ Reporting}}{NR slot length} .$$

Example Embodiment 50. The method of any of the previous example embodiments, further comprising: obtaining user data; and forwarding the user data to a host or a user equipment.

### Group C Embodiments

Example Embodiment 51. A user equipment for temporary reference signal-based secondary cell activation via radio resource control, comprising: processing circuitry configured to perform any of the steps of any of the Group A embodiments; and power supply circuitry configured to supply power to the processing circuitry.

Example Embodiment 52. A network node for temporary reference signal-based secondary cell activation via radio resource control, the network node comprising: processing circuitry configured to perform any of the steps of any of the Group B embodiments; power supply circuitry configured to supply power to the processing circuitry.

Example Embodiment 53. A user equipment (UE) for temporary reference signal-based secondary cell activation via radio resource control, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment 54. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Example Embodiment 55. The host of the previous example embodiment, wherein the cellular network further includes a network node configured to communicate with the UE to transmit the user data to the UE from the host.

Example Embodiment 56. The host of the previous 2 example embodiments, wherein: the processing circuitry of the host is configured to execute a host application, thereby providing the user data; and the host application is configured to interact with a client application executing on the UE, the client application being associated with the host application.

Example Embodiment 57. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment 58. The method of the previous example embodiment, further comprising: at the host, executing a host application associated with a client application executing on the UE to receive the user data from the UE.

Example Embodiment 59. The method of the previous example embodiment, further comprising: at the host, transmitting input data to the client application executing on the UE, the input data being provided by executing the host application, wherein the user data is provided by the client application in response to the input data from the host application.

Example Embodiment 60. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Example Embodiment 61. The host of the previous example embodiment, wherein the cellular network further includes a network node configured to communicate with the UE to transmit the user data from the UE to the host.

Example Embodiment 62. The host of the previous 2 example embodiments, wherein: the processing circuitry of the host is configured to execute a host application, thereby providing the user data; and the host application is configured to interact with a client application executing on the UE, the client application being associated with the host application.

Example Embodiment 63. A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Example Embodiment 64. The method of the previous example embodiment, further comprising: at the host, executing a host application associated with a client application executing on the UE to receive the user data from the UE.

Example Embodiment 65. The method of the previous example embodiment, further comprising: at the host, transmitting input data to the client application executing on the UE, the input data being provided by executing the host application, wherein the user data is provided by the client application in response to the input data from the host application.

Example Embodiment 66. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Example Embodiment 67. The host of the previous example embodiment, wherein: the processing circuitry of the host is configured to execute a host application that provides the user data; and the UE comprises processing circuitry configured to execute a client application associated with the host application to receive the transmission of user data from the host.

Example Embodiment 68. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Example Embodiment 69. The method of the previous example embodiment, further comprising, at the network node, transmitting the user data provided by the host for the UE.

Example Embodiment 70. The method of any of the previous 2 example embodiments, wherein the user data is provided at the host by executing a host application that interacts with a client application executing on the UE, the client application being associated with the host application.

Example Embodiment 71. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Example Embodiment 72. The communication system of the previous example embodiment, further comprising: the network node; and/or the user equipment.

Example Embodiment 73. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Example Embodiment 74. The host of the previous 2 example embodiments, wherein: the processing circuitry of the host is configured to execute a host application, thereby providing the user data; and the host application is configured to interact with a client application executing on the UE, the client application being associated with the host application.

Example Embodiment 75. The host of the any of the previous 2 example embodiments, wherein the initiating receipt of the user data comprises requesting the user data.

Example Embodiment 76. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Example Embodiment 77. The method of the previous example embodiment, further comprising at the network node, transmitting the received user data to the host.

1. A method performed by a user equipment, UE, for temporary reference signal-based secondary cell, SCell, activation via radio resource control, RRC, the method comprising:
receiving, from a network node, a RRC message indicating that the SCell is to be activated, the RRC message comprising configuration information associated with a temporary reference signal, TRS;
based on the configuration information in the RRC message, receiving the TRS; and
transmitting, to the network node, a channel state information, CSI, report for the SCell based on the TRS.

2. The method of claim 1, wherein the configuration information in the RRC message indicates the TRS to be used to activate the SCell.

3. The method of claim 1, wherein the configuration information indicates a time slot for receiving the TRS, and wherein the method comprises receiving the TRS at the time slot indicated in the RRC message.

4. The method of claim 3, wherein the RRC message indicates the time slot for receiving the TRS by indicating a system frame number, SFN, and a subframe number.

5. The method of claim 4, wherein the RRC message indicates a slot number within the subframe number.

6. The method of claim 4, wherein the time slot for receiving the TRS is a fixed slot in the subframe number.

7. The method of claim 1, wherein one or more of:
the configuration information indicates a triggering offset after a reference slot, and wherein the method comprises receiving the TRS according to the triggering offset after the reference slot;
the reference slot is a slot in which the RRC message is received;
the triggering offset is a fixed value; and
the fixed value is related to a RRC message process delay time.

8.-10. (canceled)

11. The method of claim 7, wherein one or both:
the triggering offset is set by the user equipment; and
the RRC message indicates the triggering offset.

12. (canceled)

13. The method of claim 1, wherein the RRC message is:
a RRC reconfiguration message in which the SCell is added;
a RRC reconfiguration message for handover;
a RRC reconfiguration message for RRC Resume; or
a RRC reconfiguration message to activate a deactivated secondary cell group, SCG.

14. (canceled)

15. A method performed by a network node for temporary reference signal-based secondary cell, SCell, activation via radio resource control, RRC, the method comprising:
transmitting a RRC message, the RRC message indicating that the SCell is to be activated, the RRC message comprising configuration information associated with a temporary reference signal, TRS;
based on the configuration information in the RRC message, transmitting the TRS; and
receiving a channel state information, CSI, report for the SCell based on the TRS.

16. The method of claim 15, wherein the configuration information in the RRC message indicates the TRS to be used to activate the SCell.

17. The method of claim 15, wherein the configuration information indicates a time slot for receiving the TRS, and wherein the method comprises transmitting the TRS at the time slot indicated in the RRC message.

18. The method of claim 17, wherein the RRC message indicates the time slot that the TRS is transmitted by indicating a system frame number, SFN, and a subframe number.

19. The method of claim 18, wherein the RRC message indicates a slot number within the subframe number.

20. The method of claim 19, wherein the time slot for transmitting the TRS is a fixed slot in the subframe number.

21. The method of claim 15, wherein one or more of:
the configuration information indicates a triggering offset after a reference slot, and wherein the TRS is transmitted according to the triggering offset after the reference slot;
the reference slot is a slot in which the RRC message is transmitted;
the triggering offset is a fixed value; and
the fixed value is related to a RRC message process delay time.

22.-24. (canceled)

25. The method of claim 21, wherein one or both:
the triggering offset is set by the user equipment; and
the RRC message indicates the triggering offset.

26. (canceled)

27. The method of claim 15, wherein the RRC message is:
a RRC reconfiguration message in which the SCell is added;
a RRC reconfiguration message for handover;
a RRC reconfiguration message for RRC Resume; or
a RRC reconfiguration message to activate a deactivated secondary cell group, SCG.

28. (canceled)

29. A user equipment, UE, for temporary reference signal-based secondary cell, SCell, activation via radio resource control, RRC, the UE comprising:
processing circuitry configured to:
receive a RRC message indicating that a secondary cell, SCell, is to be activated, the RRC message comprising configuration information associated with a temporary reference signal, TRS;
based on the configuration information in the RRC message, receive the TRS; and
transmit a channel state information, CSI, report for the SCell based on the TRS.

30. (canceled)

31. (canceled)

32. A network node for temporary reference signal-based secondary cell, SCell, activation via radio resource control, RRC, the network node comprising:
processing circuitry configured to:
transmit a RRC message indicating that the SCell is to be activated, the RRC message comprising configuration information associated with a temporary reference signal, TRS;
based on the configuration information in the RRC message, transmit the TRS; and
receive a channel state information, CSI, report for the SCell based on the TRS.

33. (canceled)

34. (canceled)
